(19) United States
(12) Patent Application Publication
(10) Pub. No.: US 2004/0162998 A1
(43) Pub. Date: Aug. 19, 2004

(54) Service authentication in a communication system

(76) Inventors: Jukka Tuomi, Tampere (FI); Auvo Hartikainen, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/411,364

(22) Filed: Apr. 11, 2003

Related U.S. Application Data
(60) Provisional application No. 60/447,330, filed on Feb. 14, 2003.

(51) Int. Cl. H04L 9/32

(52) U.S. Cl. 713/202

(57) ABSTRACT

The invention concerns authentication in an access network. In order to be able to utilize the infrastructure of a separate mobile communication network for the authentication of subscribers with traditional (non-SIM) terminals, a subscriber is provided with a first password comprising a first element derived from a second password stored in the mobile communication network. When the subscriber enters the access network, a first request is sent to the mobile communication network, the first request triggering in the mobile communication network the sending of a first response which requests the second password. A third password is then sent to the mobile communication network as a response, the third password being derived from the first element. The third password is matched against the second password and the service is provided to the subscriber when the matching indicates that the third password and the second password have a predetermined relationship.

### CROSS REFERENCE TO RELATED APPLICATIONS

This application claims priority of U.S. Provisional Patent Application Serial No. 60/447,330, entitled “Service Authentication in a Communication System,” filed on Feb. 14, 2003, the contents of which are hereby incorporated by reference.

### BACKGROUND OF THE INVENTION

1. Field of the Invention

The invention relates generally to service authentication in a communication system. More specifically, the invention relates to a process in which the infrastructure of a mobile communication network is utilized for authenticating a user of another network external to the mobile communication network when a service is to be provided to the said user. The external network is typically an access network, such as a WLAN network, while the service is an access service providing the user with connectivity.

2. Description of the Related Art

The current development towards truly mobile computing and networking has brought on the evolvement of various access technologies, which also provide the users with access to the Internet when they are outside their own home network. At present, wireless Internet access is typically based on either wireless LAN technology or mobile networks, or both.

In wireless LAN technology, the mobile terminals are provided with wireless LAN cards, whereby they can access the Internet through wireless LAN access points, which are mainly located in various hot spots, such as airports, convention centers, railway stations, or shopping malls.

An example of the new mobile network technologies enabling Internet access is GPRS (General Packet Radio Service). GPRS aims at providing high-quality services for present GSM subscribers by efficiently utilizing the current network infrastructure and protocols. GPRS evolved from GSM with the introduction of two new network elements: SGSN (Serving GPRS Support Node) and GGSN (Gateway GPRS Support Node). These elements also provide packet-based services in the upcoming UMTS (Universal Mobile Telecommunication System) networks.

The mobile and LAN technologies can also complement each other. An example of this is SIM (Subscriber Identity Module) authentication, which is becoming more common in public WLAN networks. In SIM authentication, the mobile equipment of the user, such as a laptop, PDA or an intelligent phone, is provided with the SIM card of a mobile communication network, such as the GSM network, and an authentication process is performed, which is highly similar to the one used to authenticate a user in the mobile communication network. The subscriber-specific information (i.e. subscriber profile) and the subscriber-specific authentication information available in the mobile network can also be copied for the WLAN environment so that SIM-based authentication can be performed locally when the user enters the WLAN network and so that access service can be provided based on the subscriber profile.

So-called multimode radio cards are also becoming more and more common in user devices. Having his or her mobile terminal equipped with a multimode radio card, the user can choose the network type most suitable in each case, i.e. the user can choose whether the services are accessed through GPRS or WLAN, for example.

A drawback relating to present WLAN authentication mechanisms is that separate core network systems have to be provided for SIM-based terminals and other terminals. In other words, traditional non-SIM terminals are not capable of performing the SIM-based authentication and require a separate core network system for authentication. It would, however, be desirable to be able to utilize the mobile network infrastructure with respect to the authentication of these terminals as well.

### SUMMARY OF THE INVENTION

The objective of the invention is to eliminate the above-mentioned drawback. In other words, the objective of the invention is to devise a mechanism that enables users with non-SIM terminals to be authenticated by utilizing the mobile network infrastructure.

In the present invention, the features and functionalities of the mobile network are utilized by using a WLAN password that comprises a first element, which depends, in a predetermined manner, on a second password stored in the mobile network. The second password is typically a password that a mobile subscriber may use to control a service provided in the mobile communication network. Services of this type are in this context termed supplementary services. When a WLAN user requests a service, such as a WLAN access service, the WLAN password is sent from the terminal to the WLAN network. The WLAN network then sends the mobile communication network a message that triggers in the mobile communication network the sending of a response which requests the second password, i.e. the WLAN network misleads the mobile communication network to believe that a mobile subscriber wants to control a supplementary service. A third password is then sent to the mobile communication network as a response, the third password being derived from the first element of the WLAN password. The third password is matched against the second password stored in the mobile communication network. The authentication is deemed as successful if the matching indicates that the third and second passwords have a predetermined relationship. The first element typically equals the second password and the third password equals the first element, whereby the third password returned to the mobile communication network equals the second password. A perfect match is then required in order for the authentication to be successful.

Although a typical use of the invention concerns the authentication of WLAN users by means of a mobile network infrastructure, the mechanism of the invention may be used in connection with any service authentication, provided that the network through which the service is requested can utilize another network similarly as the WLAN network utilizes the mobile communication network in the method of the invention. Generally, there are thus two networks involved: a first network, which is typically a WVLAN network, and a second network, which is typically a mobile communication network.

Thus one aspect of the invention is the provision of an authentication method for a service provided in a communication system. The method includes the steps of providing a user of a first network with a first password comprising a first element derived from a second password stored in a second network external to the first network and in response to the user requesting a service from the first network, supplying the first password to the first network. The method also includes transmitting from the first network a first request to the second network, the first request being such that it triggers in the second network the sending of a first response which requests the second password, and in response to the first response, sending a third password to the second network, the third password being derived from the first element. The method also includes matching the third password against the second password stored in the second network and offering the service to the user when the matching step indicates that the third password and the second password have a predetermined relationship.

In a further aspect the invention provides an authentication system for a service provided in a communication system. The authentication system includes means for supplying a first password to a first network, the first password comprising a first element derived from a second password stored in a second network, the first network being external to the second network, and first signaling means for sending a first request to the second network, the first request being such that it triggers in the second network the sending of a first response which requests the second password. The authentication system also includes second signaling means, responsive to the first response, for sending a third password to the second network, the third password being derived from the first element, and matching means for matching the third password against the second password stored in the second network.

In another aspect the invention provides a network element for authenticating users in a first network. The network element includes first reception means for receiving a first password comprising a first element derived from a second password stored in a second network external to the first network, first signaling means for sending a first request to the second network, the first request being such that it triggers in the second network the sending of a first response which requests the second password and second signaling means, responsive to the first response, for sending a third password to the second network, the third password being derived from the first element. The network element also includes second reception means for receiving a notification indicating whether the third password and the second password have a predetermined relationship and means for generating an authentication result on the basis of the notification.

By means of the solution of the invention the mobile communication network infrastructure may be efficiently utilized for authenticating subscribers with non-SIM terminals. In other words, users with non-SIM terminals can be treated as SIM-based users. This also entails the efficient utilization of the billing and charging systems of the mobile communication network, for example.

The supplementary services provided in a mobile communication network are typically such that the network prohibits further control of the service if a user gives an incorrect password for three consecutive times. Therefore, to prevent malicious users from locking services of other subscribers, one embodiment of the invention includes a further mechanism for preventing such incidents. This is implemented by providing the WLAN password with a second element, which is checked before the above-described check of the first element. The second element is derived from an identifier, which the mobile communication network uses to identify the subscriber. This identifier is typically an International Mobile Subscriber Identity (IMSI). The WLAN network retrieves the identifier from the mobile communication network and compares it with the second element of the WLAN password. If this comparison does not show that the second element supplied by the user and the identifier have a certain predetermined relationship, the authentication process is not continued any further and the service is denied.

A further advantage of the invention is that the global SS7 signaling network may be utilized for authenticating roaming WLAN users. In other words, the technology already exists, which allows roaming WLAN users to be authenticated according to the invention.

A still further advantage of the invention is that the WLAN password can easily be changed by a mobile phone, by changing the first element of the WLAN password, since the supplementary service password can be controlled by the user.

Other features and advantages of the invention will become apparent through reference to the following detailed description and accompanying drawings.

### BRIEF DESCRIPTION OF THE DRAWINGS

In the following, the invention and its preferred embodiments are described more closely with reference to the examples shown in FIGS. 1 to 4 in the appended drawings, wherein:

FIG. 1 illustrates a typical communication system according to the invention;

FIG. 2 illustrates the WLAN password utilized in the present invention;

FIG. 3 illustrates the message exchange in the authentication process of the invention; and

FIG. 4 is a block diagram illustrating the elements of the authentication server.

### DETAILED DESCRIPTION OF THE PREFERRED EMBODIMENTS

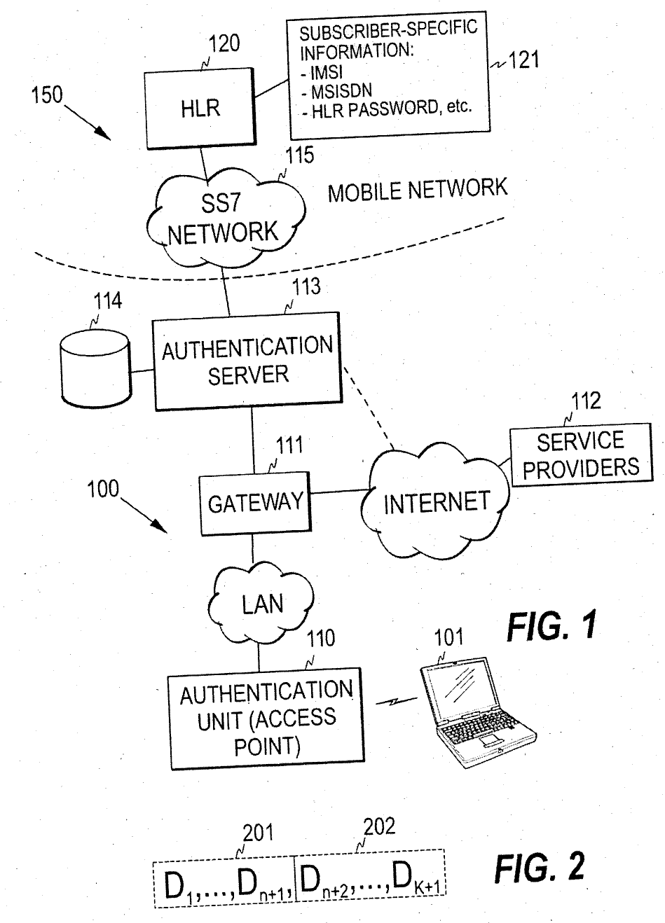

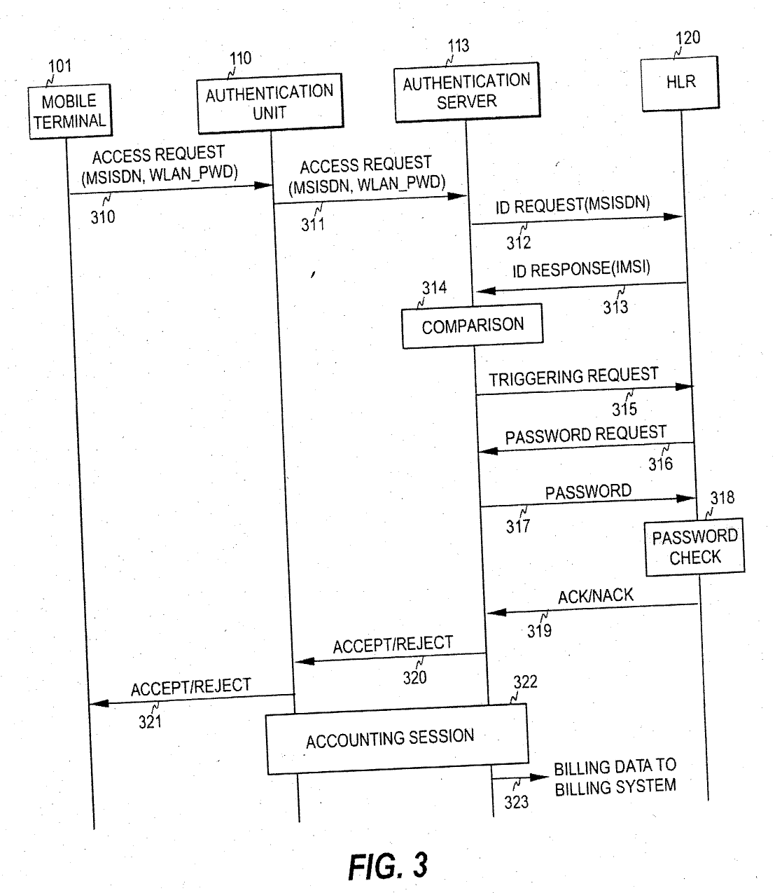

FIG. 1 illustrates a typical communication system according to the invention. The system includes one or more WLAN networks 100, each being connected by means of a gateway GW (a router) 111 to another network, such as the Internet, which contains service providers 112. Each WLAN network comprises one or more authentication units 110, each communicating wirelessly with the terminals within its coverage and thus forming a bridge between the terminals and the wired LAN, which is typically an Ethernet LAN, within which TCP/IP packets are transmitted. The authentication unit includes a physical access point (i.e. base station). However, as this unit further includes access control functions, it is termed an authentication unit in this context. In view of the invention, the authentication unit is an entity that communicates with the terminal and blocks user traffic before the terminal is successfully authenticated.

The above control functions may also be performed by the gateway, i.e. the gateway may operate as the authentication unit.

Users moving in the area of the WLAN network may use portable computers, PDA equipment, intelligent phones or other such mobile terminals 101. As the invention allows non-SIM terminals (i.e. terminals not compatible with the SIM-based authentication mechanism) to be authenticated by means of the mobile network infrastructure, it is assumed here that the terminals are traditional WLAN terminals with no SIM cards. However, the authentication mechanism of the invention may also be utilized by a user having a terminal with a SIM-based authentication capability, for example when the SIM card is not inserted into the terminal device.

The heart of the system is an authentication server 113 of the WLAN network. The authentication server is connected to the gateway through a secured connection, which is typically a TCP/IP connection established through the operator network or through the Internet. In addition, the authentication server has access through a signaling network, such as the SS7 network 115, to a separate mobile communication network 150, which may be a GSM network or an UMTS network, for example. The authentication server further includes a database 114, which stores the data retrieved from the mobile network, for example.

The authentication server communicates with the HLR (Home Location Register) 120 storing the subscriber profiles in the mobile communication network.

In mobile communication networks, some supplementary services, such as call barring, are offered to subscribers with the option of using a password to control the service. Every time the subscriber wants to control the service, such as activate or deactivate the service, he/she has to enter the correct password before the network allows the service to be controlled. The password is stored in the subscriber profile in the HLR. In GSM or UMTS networks, the length of the password is 4 digits. Below, this supplementary service password is termed the HLR password.

In the present invention, the HLR password, the Mobile Subscriber International ISDN Number (MSISDN), and the International Mobile Subscriber Identity (IMSI) of a mobile subscriber are utilized in the WLAN authentication process. As shown in FIG. 1, all these data items are stored in the subscriber profile 121 residing in the HLR. As is known, the MSISDN is the directory number of the mobile subscriber, while the IMSI is a unique identification number used by the mobile communication network to identify the subscriber. A subscriber has only one IMSI but may have several MSISDN numbers. The IMSI and the MSISDN number(s) are tied together in the HLR.

In the following example, it is assumed that a subscriber with the following identification information enters a WLAN network:

MSISDN=+358 40 5813317

IMSI=234 . . . 5678 (15 digits)

HLR password=1234.

In one embodiment of the invention, the subscriber is given a WLAN password of the type shown in FIG. 2. The password comprises a first element 201 derived from the HLR password of the subscriber, and a second element 202 derived from the IMSI of the subscriber. In the example of FIG. 2, the length of the password is K digits (Dᵢ), the first element comprising n digits and the second element K-n digits. The WLAN password may be given to the subscriber in connection with subscription to the WLAN service, for example.

In this example, it is assumed that the subscriber is given a WLAN password 12345678, i.e. a password in which the first element (1234) corresponds directly to the HLR password and the second element (5678) directly to the four last digits of the IMSI of the subscriber in question.

When the subscriber enters the WLAN network, the terminal is sent a login page from the authentication unit, i.e. a user ID and password prompt is displayed on the terminal. The user then enters the MSISDN as the user ID and the WLAN password as the password. The terminal sends the said information to the authentication unit in an access request (step 310). Various mechanisms may be used to encrypt the messages transferred across the radio interface and to protect the WLAN password. For example, Secure Socket Layer (SSL) protocol may be used between the terminal and the authentication unit.

The authentication unit forwards the user ID and the WLAN password to the authentication server (step 311). The protocol used between the authentication unit and the authentication server is an AAA (Authentication Authorization Accounting) protocol, typically RADIUS or DIAMETER.

When the authentication server receives the user ID (i.e. the MSISDN) and the WLAN password, it retrieves the IMSI of the subscriber from the HLR. This is implemented so that the authentication server sends the HLR an ID request through the SS7 network, the ID request requesting the IMSI of the subscriber identified by the MSISDN included in the request (step 312). The actual request sent by the authentication server in the GSM/UMTS environment of FIG. 1 is the MAP_SEND_IMSI request (defined in 3GPP Technical Specification TS 09.02 v.7.11.0, for example). Here, the authentication server emulates a Visitor Location Register (VLR), which is the entity in a mobile communication network that normally sends the said request to the HLR. When the HLR receives the request, it identifies the subscriber on the basis of the MSISDN included in the request, and returns (step 313) the corresponding IMSI in a response, which in the above environment is the MAP_SEND_IMSI_ACK response (also defined in the above-mentioned specification, for example).

The authentication server then compares the IMSI received from the HLR with the second element of the WLAN password received from the authentication unit (step 314). Using the above example, the authentication server extracts the last four digits of the IMSI received from the HLR and matches them against the second element of the WLAN password received from the authentication unit. If the digits do not match, the authentication server informs the authentication unit that access is denied due to an incorrect password (not shown in the figure).

However, in a normal case the digits match and the authentication process may continue. The authentication server then sends the HLR a request, which triggers the HLR to request the HLR password from the authentication server (step 315). One service that may be used to implement this in the GSM/UMTS environment of FIG. 1 is the MAP_ACTIVATE_SS service (defined in 3GPP Technical Specification TS 09.02 v.7.11.0, for example). This service is normally used between the MSC and the VLR and between the VLR and the HLR to activate a supplementary service, i.e. normally the VLR relays the message from the MSC to the HLR. Thus, here the authentication server emulates the MSC or the VLR as if the subscriber were about to control the supplementary service.

In response to this, the HLR initiates a MAP_GET_PASSWORD service and returns a password request to the authentication server (step 316). This service is normally used between the HLR and the VLR and between the VLR and the MSC when the HLR receives the above request from the subscriber for an operation on a supplementary service that requires a password from the subscriber, i.e. the VLR relays the message from the VLR to the MSC. In the present invention, this service is thus used to request the HLR password from the authentication server, the service being activated by the triggering request sent at step 315.

The authentication server then sends the HLR the first element of the WLAN password received from the authentication unit (step 317). The HLR checks the password contained in the first element (step 318), and returns an accept or reject message (step 319), depending on whether the password given by the authentication server is correct or incorrect, respectively. As the ACK/NACK (acknowledged/not acknowledged) response returned by the HLR is normally an acknowledgment to the MAP_ACTIVATE_SS message, a NACK may also be caused by an event other than an unsuccessful password check. Therefore, it is assumed here that the operation that triggers the sending of the password request does not trigger in the HLR any such operations that would make the reception of a NACK message ambiguous.

The authentication server then sends the result of authentication to the authentication unit (step 320), using the AAA protocol used between the authentication unit and the authentication server. The authentication unit in turn informs the terminal of the authentication result (step 321).

After a successful authentication, the terminal is allowed to send data to the network and receive data from the network, and an accounting session 322 is established between the authentication unit and the authentication server, during which the authentication unit sends accounting messages to the authentication server. When the terminal logs out, the accounting session is terminated and the authentication server generates at least one charging data record and sends it to the billing system associated with the mobile communication network (step 323). The billing system adds the information contained in the charging data record to the bill of the subscriber.

In the above example, the authentication process includes two comparisons: first the authentication server compares the second element of the WLAN password with the IMSI and then the HLR compares the first element of the WLAN password with the HLR password. The first comparison prevents malicious users from locking services of other subscribers by supplying an incorrect HLR password for three consecutive times. Therefore, the authentication process does not continue any further, if the IMSI check at step 314 is not passed. However, if the mobile communication network provides a password-controlled service that cannot be locked by supplying wrong passwords, it is possible to use the WLAN password without the second element. Thus in this case the WLAN password comprises the first element only (and steps 312 to 314 may be omitted).

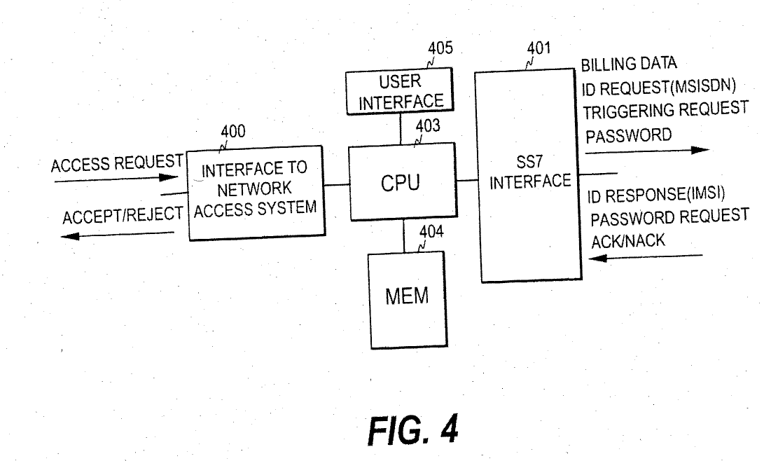

FIG. 4 illustrates the basic elements of the authentication server in view of the invention. The authentication server thus comprises two interfaces, an interface 400 to the network access system and an SS7 interface 401, which are controlled by a control unit 403. The server further comprises memory means 404 (which include the database of FIG. 1) and user interface means 405. Through the access system interface 400 the authentication server communicates with the authentication unit using an AAA protocol, such as RADIUS or DIAMETER, and through the SS7 interface 401 with the HLR using the MAP protocol. The messages traveling in each direction are shown in the figure. As discussed above, the billing data is also transferred through the SS7 interface to the mobile communication system.

In the above examples the first element of the WLAN password corresponds to the password of the supplementary service. However, as discussed above, these two words (character strings), which are compared with each other by the HLR, may also differ from each other, providing they have a predetermined relationship so that the authentication process can unambiguously determine, whether the first element supplied to the WLAN network has the predetermined relationship with the HLR password. The same applies to the second element and the IMSI compared with each other. Consequently, the words to be compared with each other may be modified by the authentication server and/or the HLR, provided that the predetermined relationship can still be verified unambiguously. For example, an algorithm may by used to calculate a digest from the IMSI for the WLAN password. When receiving the IMSI, the authentication server calculates the digest (using the same algorithm) and compares the result with the second element of the WLAN password. The known challenge-response method may also be used to verify whether the two words correspond to each other. The authentication server may, for example, give the terminal a random number. The terminal then calculates, using a certain algorithm, a response on the basis of the random number and the element in the WLAN password. When the authentication server receives the information (identifier or password) from the mobile communication network, it verifies, using the same algorithm and random number, whether the two words correspond to each other.

In the above example, the MAP_ACTIVATE_SS service was used to trigger the HLR to send the password request. As is obvious, any other operation that triggers the sending of the password request may be used instead. However, it is preferable to select an operation that does not cause additional measures in the HLR.

Depending on the identifiers used in the mobile communication network in question, the MSISDN may be replaced by another public identifier and the IMSI by another private identifier. Furthermore, the network element holding the password does not necessarily have to be the HLR, provided that the password request can be triggered similarly as above. It is also possible that the private identifier is requested from another network element than the one holding the password.

As is also obvious from the above, the authentication method of the invention may be always implemented when the WLAN user is also a mobile subscriber. Even though it is highly likely that a person who is a WLAN user also possesses a mobile phone, it is possible that the operator creates a virtual mobile subscription in case the WLAN user has no mobile phone. The virtual subscription then involves the generation of the above information (IMSI, MSISDN, HLR password) in the network element containing subscriber profiles, such as the HLR.

Although the invention was described above with reference to the examples shown in the appended drawings, it is obvious that the invention is not limited to these, but may be modified by those skilled in the art without departing from the scope and spirit of the invention. As mentioned above, any first network may utilize a second network for authentication purposes in the above-described manner, provided that the second network offers the above-described characteristics of a mobile communication network so that the first network is able to utilize the second network in the above-described manner. Furthermore, the invention is not restricted to access services, but can be used for authentication in connection with any service accessed through the first network. The service provided may thus be another service than the access service described above. Therefore, the invention is not restricted to WLAN networks only, but can be used in connection with any access system external to the mobile communication network or a similar second network, regardless of the actual access technology. Such an access system may be a Bluetooth or a UWB (Ultra Wide Band) based access system, for example. The method can even be used in conjunction with fixed terminals.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. An authentication method for a service provided in a communication system, the method comprising the steps of:
providing a user of a first network with a first password comprising a first element derived from a second password stored in a second network external to the first network;
in response to the user requesting a service from the first network, supplying the first password to the first network;
transmitting from the first network a first request to the second network, the first request being such that the first request triggers in the second network a sending of a first response which requests the second password;
in response to the first response, sending a third password to the second network, the third password being derived from the first element;
matching the third password against the second password stored in the second network; and
offering the service to the user when the matching step indicates that the third password and the second password have a predetermined relationship.

2. A method according to claim 1, further comprising the steps of:
providing the first password with a second element derived from a first identifier used to identify the user in the second network;
sending a second request from the first network to the second network, the second request being such that the second request triggers in the second network a sending of a second response which includes the first identifier stored in the second network;
comparing the first identifier included in the second response with the second element of the first password;
wherein the comparing step is performed prior to the transmitting step, the transmitting step being performed when the comparing step indicates that the first identifier included in the second response has a predetermined relationship with the second element.

3. A method according to claim 2, wherein the second network is a mobile communication network.

4. A method according to claim 2, wherein the first network is an access network.

5. A method according to claim 1, wherein the first element equals the second password stored in the second network.

6. A method according to claim 1, wherein the third password equals the first element.

7. A method according to claim 2, wherein the first identifier includes a character string and the second element comprises a substring of the first identifier.

8. A method according to claim 3, wherein the first identifier is an International Mobile Subscriber Identity (IMSI) of the user.

9. A method according to claim 3, wherein the second password is used for controlling the service in the mobile communication network.

10. A method according to claim 9, wherein the first request is a message according to a MAP_ACTIVATE_SS service.

11. A method according to claim 8, wherein the second request is a MAP_SEND_IMSI request.

12. A method according to claim 3, wherein the supplying step further includes supplying a user identifier to the first network, the user identifier being a public identifier used in the mobile communication network.

13. A method according to claim 12, wherein the user identifier is a Mobile Subscriber International ISDN Number (MSISDN) of the user.

14. A method according to claim 4, wherein the offering step includes allowing the user to access the access network, whereby the service being offered is an access service.

15. An authentication system for a service provided in a communication system, the authentication system comprising:
means for supplying a first password to a first network, the first password comprising a first element derived from a second password stored in a second network, the first network being external to the second network;
first signaling means for sending a first request to the second network, the first request being such that the first request triggers in the second network a sending of a first response which requests the second password;
second signaling means, responsive to the first response, for sending a third password to the second network, the third password being derived from the first element; and
matching means for matching the third password against the second password stored in the second network.

16. An authentication system according to claim 15, wherein the first password further comprises a second element derived from a first identifier used to identify a user in the second network, the authentication system further comprising:
third signaling means for sending a second request from the first network to the second network, the second request being such that the second request triggers in the second network a sending of a second response which includes the first identifier stored in the second network;
comparison means for comparing the first identifier included in the second response with the second element of the first password;
wherein the first signaling means are responsive to the comparison means.

17. An authentication system according to claim 16, wherein the second network is a mobile communication network.

18. An authentication system according to claim 17, wherein the first network is an access network.

19. An authentication system according to claim 18, wherein the access network is a WLAN network and the service is an access service providing access to the WLAN network.

20. A network element for authenticating users in a first network, the network element comprising:
first reception means for receiving a first password comprising a first element derived from a second password stored in a second network external to the first network;
first signaling means for sending a first request to the second network, the first request being such that the first request triggers in the second network a sending of a first response which requests the second password;
second signaling means, responsive to the first response, for sending a third password to the second network, the third password being derived from the first element;
second reception means for receiving a notification indicating whether the third password and the second password have a predetermined relationship; and
means for generating an authentication result on the basis of the notification.

21. A network element according to claim 20, the network element further comprising:
third signaling means for sending a second request from the first network to the second network, the second request being such that the second request triggers in the second network a sending of a second response which includes a first identifier stored in the second network, the first identifier identifying the user in the second network;
comparison means for comparing a first identifier included in the second response with a second element in the first password, the second element being derived from the first identifier;
wherein the first signaling means are responsive to the comparison means.
